(19) United States
(12) Patent Application Publication
(10) Pub. No.: US 2019/0375511 A1
(43) Pub. Date: Dec. 12, 2019

(54) MONOLITHIC TRANSMISSION SUPPORT FOR ROTORCRAFT

(71) Applicant: Bell Helicopter Textron Inc., Fort Worth, TX (US)

(72) Inventors: Olivier André Boisvert, Mirabel (CA); Kevin Donald Morris, Hawkesbury (CA); Sébastien Duval, Terrebonne (CA)

(73) Assignee: Bell Helicopter Textron Inc., Fort Worth, TX (US)

(21) Appl. No.: 16/005,406

(22) Filed: Jun. 11, 2018

(51) Int. Cl. B64D 35/00; B64C 27/12; B29C 70/34

(52) U.S. Cl. CPC B64D 35/00; B29K 2105/256; B29C 70/34; B64C 27/12

(57) ABSTRACT

A transmission support for securing a transmission to a rotorcraft includes two side beams each including a roof beam portion configured to be secured to structural elements of the rotorcraft cabin, and a pylon beam portion extending from the roof beam portion toward the other of the side beams. The pylon beam portion is configured to engage the transmission upon the transmission being received between the side beams. The support further has cross beams extending between and interconnecting the two side beams. The side beams and cross beams are part of a monolithic structure. A method of manufacturing the transmission support is provided.

### TECHNICAL FIELD

The application relates generally to rotorcrafts and, more particularly, to structural composite parts of a roof of a rotorcraft.

### BACKGROUND

On traditional rotorcraft, a roof structure is built using a plurality of primary structural elements such as roofs beams, cross members, intercostal and transmission fittings. The high number of parts may render installation of the transmission support on the rotorcraft cumbersome and time consuming, due for example to the significant number of fasteners which create tension joints at the interface fittings.

### SUMMARY

According to an aspect, there is provided a transmission support configured for securing a transmission on a roof of a rotorcraft cabin, the transmission support comprising: two side beams each including: a roof beam portion extending along a longitudinal direction and configured to be secured to structural elements of the rotorcraft cabin, the two side beams spaced apart from each other along a transverse direction perpendicular to the longitudinal direction, and a pylon beam portion extending from the roof beam portion toward the other of the side beams, the pylon beam portion configured to engage the transmission upon the transmission being received between the side beams; and cross beams extending between and interconnecting the two side beams, the cross beams spaced apart from each other along the longitudinal direction; wherein the side beams and cross beams are part of a monolithic structure.

According to another aspect, there is provided a monolithic transmission support configured for securing a transmission on a roof of a rotorcraft cabin, the monolithic transmission support comprising two side beams spaced apart from each other along a transverse direction and interconnected to each other via cross beams, the cross beams spaced apart from each other along a longitudinal direction, the longitudinal direction perpendicular to the transversal direction, each of the two side beams including a roof beam portion configured to be received on the roof and to be secured to structural elements of the rotorcraft cabin and a pylon beam portion configured to engage the transmission upon the transmission being received between the side beams, the pylon beam portion protruding from the roof beam portion.

According to another aspect, there is provided a method of forming a monolithic transmission support for a rotorcraft, comprising: laying uncured composite on a mold surface to form two side beams and to form cross-beams interconnecting the side beams, each side beam being formed to include a roof beam portion and a pylon beam portion; and curing the composite material to obtain the monolithic transmission support.

### DESCRIPTION OF THE DRAWINGS

Reference is now made to the accompanying figures in which:

FIG. 1 is a schematic side view of a rotorcraft in accordance with a particular embodiment;

FIG. 2 is a schematic exploded tridimensional view showing a portion of the rotorcraft of FIG. 1 and a transmission support in accordance with one embodiment; and

FIG. 3 is a schematic tridimensional view of the transmission support of FIG. 2.

### DETAILED DESCRIPTION

Illustrative embodiments of the methods and apparatuses are described below. In the interest of clarity, all features of an actual implementation may not be described in this specification. It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “top”, “bottom”, “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

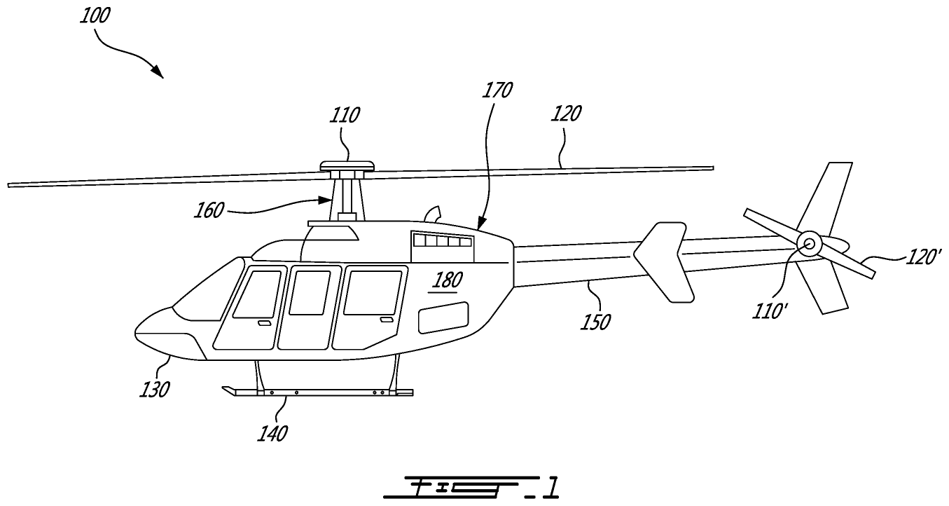

FIG. 1 shows a rotorcraft 100 according to one example embodiment. Rotorcraft 100 features a rotor system 110, blades 120, a fuselage 130 defining a cabin 180, a landing gear 140, and an empennage 150. Rotor system 110 rotates blades 120. Rotor system 110 includes a control system for selectively controlling the pitch of each blade 120 in order to selectively control direction, thrust, and lift of rotorcraft 100. Fuselage 130 represents the body of rotorcraft 100 and is coupled to rotor system 110 such that rotor system 110 and blades 120 may move fuselage 130 through the air. Landing gear 140 supports rotorcraft 100 when rotorcraft 100 is landing and/or when rotorcraft 100 is at rest on the ground. Empennage 150 represents the tail section of the aircraft and features components of a rotor system 110 and blades 120′. Blades 120′ may provide thrust in the same direction as the rotation of blades 120 so as to counter the torque effect created by rotor system 110 and blades 120.

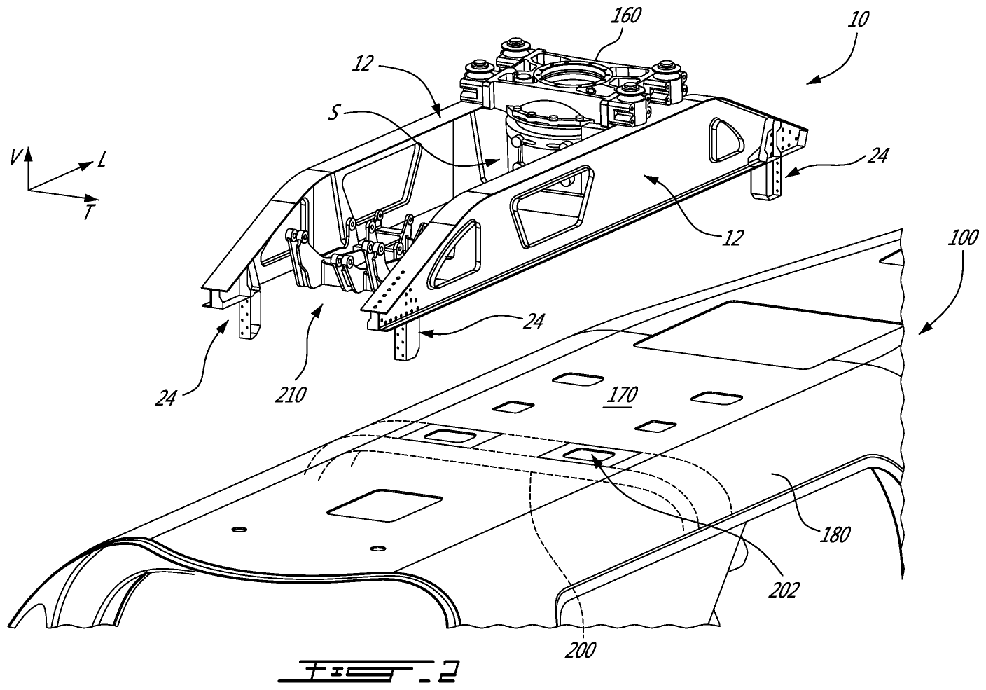

The rotorcraft 100 further includes a transmission 160 used for transmitting a rotational input from an engine of the rotorcraft 100 to the rotor system 110. The rotorcraft 100 includes a transmission support 10 (FIG. 2) configured for securing the transmission 160 on a roof 170 of the cabin 180 of the rotorcraft 100.

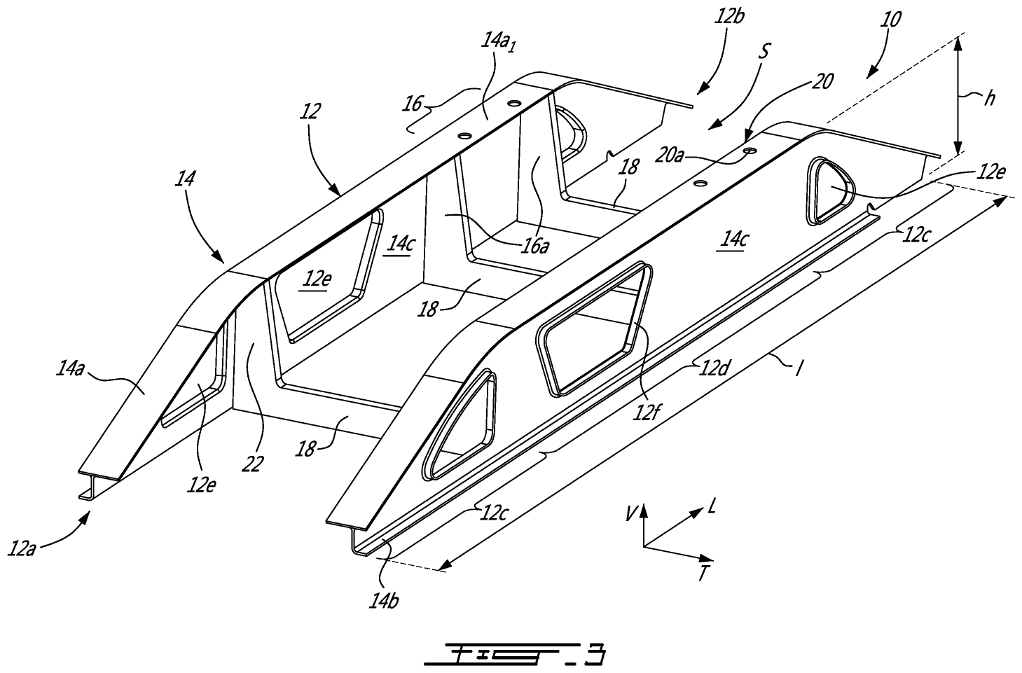

Referring now to FIGS. 2-3, the transmission support in accordance with one embodiment is generally shown at 10. The transmission support 10 is used for transferring loads generated by the rotor system 110 to the rotorcraft 100 for lifting the rotorcraft 100 off the ground. The transmission support 10 generally includes side beams 12 and cross beams 18. The side beams 12 and cross beams 18 are part of a monolithic structure. In the present specification, including claims, the term “monolithic” is intended to refer to a structure that is manufactured as a single piece, where the components are integrally connected without joints or seams, including, but not limited to, a structure having adjacent components manufactured from uncured material and simultaneously cured such as to be integrally connected to each other after the curing process. In the depicted embodiment, the monolithic structure is made of composite material including carbon fibers. It is however understood that any suitable material may be used without departing from the scope of the present disclosure.

In the embodiment shown, the support 10 includes two side beams 12 spaced apart from each other along a transverse direction T perpendicular to a longitudinal direction L. In the embodiment shown, the two side beams 12 are parallel to each other. When the transmission support 10 is installed on the rotorcraft, the longitudinal direction L corresponds to the direction of the longitudinal axis of the rotorcraft, and the transverse direction T corresponds to the direction of the lateral axis of the rotorcraft. Referring particularly to FIG. 3, the two side beams 12 have a length I defined along the longitudinal direction L and a height h smaller than the length I. The height h is defined along a vertical direction V, which is perpendicular to the longitudinal direction L and to the transverse direction T. In the depicted embodiment, the height h is defined perpendicularly to the surface of the roof 170 of the rotorcraft cabin 180 on which the side beams 12 are received. The two side beams 12 are spaced apart from each other such as to define a space S therebetween. The transmission 160 of the rotorcraft 100 is received within the space S.

Still referring to FIG. 3, each of the two side beams 12 includes a roof beam portion 14 that extends along the longitudinal direction L and a pylon beam portion 16 that extends from the roof beam portion 14 toward the other of the side beams 12. The roof beam portions 14 are securable to structural elements 200 (FIG. 2) of the rotorcraft cabin 180. These structural elements 200 may be, for instance, forward and aft lift frames of the rotorcraft cabin 180. The side beams 12 are mirror images of one another, and accordingly only one side beam 12 will be described in further detail below.

In the embodiment shown, the roof beam portion 14 includes a top horizontal flange 14a, a bottom horizontal flange 14b, and a body 14c extending from the top horizontal flange 14a to the bottom horizontal flange 14b. In the embodiment shown, the body 14c has a sheet-like configuration extending in a plane normal or substantially normal to the transverse direction T, and the flanges 14a, 14b extend parallel or substantially parallel to each other and normal or substantially normal to the body 14c. The bottom horizontal flange 14b abuts against the outer surface of the roof 170 of the rotorcraft cabin 180 when the transmission support 10 is affixed thereto, and the body 14c is generally perpendicular to the outer surface of the rotorcraft cabin roof 170. A cross-section of the roof beam portion 14 has an upper section having a “T”-shape created by an intersection of the body 14c and the top horizontal flange 14a, and a bottom section having a “L”-shape created by an intersection of the body 14c and the bottom horizontal flange 14b. Other configurations are of course possible.

In the embodiment shown, the flanges 14a, 14b extend from one end 12a of the side beams 12 to the other end 12b of the side beam 12. The side beam includes a middle section 12d interconnecting opposed end sections 12c. The end sections 12c are tapered such that a distance between the top and bottom horizontal flanges 14a, 14b decreases within the end sections 12c, becoming minimal at the ends 12a, 12b of the side beam 12. The middle section 12d of the side beam 12 contains the pylon beam portion 16. In the embodiment shown, the distance between the top and bottom horizontal flanges 14a, 14b is constant throughout the middle section 12d.

Referring back to FIGS. 2-3, the pylon beam portion 16 of the side beam 12 engages the transmission 160 when the transmission 160 is received between the side beams 12 within the space S, and transfer the load from the transmission 160 to the rotorcraft cabin 180 via the associated roof beam portion 14. Referring particularly to FIG. 3, in the embodiment shown, a portion 14a₁ of the top horizontal flange 14a of the roof beam portion 14 also defines part of the pylon beam portion 16. The pylon beam portion 16 includes pylon beam bodies 16a, two in the depicted embodiment, that extend downwardly from the top horizontal flange 14a and that are spaced apart from each other along the longitudinal direction L by a distance corresponding to a length of the portion 14a₁ of the top horizontal flange 14a forming part of the pylon beam portion 16. In the embodiment shown, the pylon beam bodies 16a extend parallel to each other and perpendicularly intersect the top horizontal flange 14a. Accordingly, the portion 14a₁ of the top horizontal flange 14a and two pylon beam bodies 16a cooperate to together define an inverted U-shape for the pylon beam portion 16; other configurations are also possible. The pylon beam bodies 16a protrude from the body 14c of the roof beam portion 14 within the space S, i.e. toward the other side beam 12.

The pylon beam portions 16 are configured to transfer loads from the transmission 160 to the cabin 180 via the portion 14a₁ of the top horizontal flange 14a and the pylon beam bodies 16a, and via the associated roof beam portion 14. In use, the transmission 160 is secured to the portion 14a₁ of the top horizontal flange 14a extending between the two pylon beam bodies 16a. The portion 14a₁ of the top horizontal flange 14a thus defines a transmission securing interface 20 for attaching the transmission 160 to the pylon beam portions 16. In the embodiment shown, the transmission securing interface 20 includes apertures 20a defined through the top horizontal flange 14a. The apertures 20a may receive any suitable type of fasteners used for securing the transmission 160 to the transmission support 10. In the embodiment shown, the transmission securing interface 20 of each side beam 12 includes two apertures 20a; other configurations are also possible.

Referring back to FIGS. 2-3. in the depicted embodiment, each of the two side beams 12 further has a beam body 22 located in the middle section 12d, spaced apart from the pylon beam portion 16 along the longitudinal direction L. The beam body 22 extends from the roof beam portion 14 toward the other of the side beams 12. In the embodiment shown, the beam body 22 perpendicularly intersects the top horizontal flange 14a. In the depicted embodiment, the beam bodies 22 and the pylon beam portions 16a have a same shape. The beam body 22 supports other elements 210 (FIG. 2) of the rotorcraft 100. These other elements 210 may be, for instance, control components such as a control support assembly on which control servo actuators are mounted, an oil reservoir, or a hydraulic fluid reservoir.

In the embodiment shown, each of the two side beams 12 has three cut-outs 12e defined therethrough, spaced from each other along the longitudinal direction L. It is understood that the number of cut-outs 12e may be varied, and that alternately the cut-outs 12e may be omitted. The cut-outs 12e are defined through the body 14c of the roof beam portion 14, for example to reduce a weight of the transmission support 10. The cut-outs 12e may also act as an access opening and help to facilitate servicing. In the embodiment shown, one of the cut-outs 12e is located in one of the end sections 12c between the pylon beam portion 16 and the adjacent end 12a of the side beam 12, another one of the cut-outs 12e is located in the middle section 12d between the beam body 22 and the pylon beam portion 16, and the third cut-out 12e is located in the other end section 12c between the beam body 22 and the adjacent end 12a of the side beam 12; accordingly, the pylon beam portion 16 is located between two of the cut-outs 12e, and the beam body 22 is also located between two of the cut-outs 12e. As can be best seen in FIG. 3, in the embodiment shown each of the cut-outs 12e is circumferentially surrounded by a respective rib 12f protruding from the body 14c of the roof beam portion 14, i.e. the rib 12f extends around the perimeter of the cut-out 12e. As shown, the ribs 12f protrude from the body 14c away from the other side beam 12. Other configurations are contemplated.

Still referring to FIG. 3, the transmission support 10 includes three cross beams 18 that extend between the two side beams 12. The cross beams 18 interconnect the two side beams 12 such that the cross beams 18 and side beams 12 are part of the monolithic structure. As shown, the cross beams 18 are spaced apart from each other along the longitudinal direction L. In the embodiment shown, the cross beams 18 are parallel to each other and perpendicularly intersect the side beams 12. Other configurations are also possible.

A first one of the cross beams 18 interconnects the side beams 12 by interconnecting the beam bodies 22 of the side beams 12; the cross beam 18 is thus secured to the two roof beam portions 14 via the two beam bodies 22. In the embodiment shown, a combination of the first cross beam 18 with the beam bodies 22 defines a continuous “U”-shape. The two other cross beams 18 interconnect the side beams 12 by being connected to a respective pylon beam body 16a of each side beam 12; these cross beams 18 are thus secured to the roof beam portions 14 via the pylon beam portions 16. In the embodiment shown, each of the two other cross beams 18 thus defines a continuous “U”-shape with the associated pylon beam body 16a on each side.

Referring to FIG. 2, in use, the transmission support 10 is secured to the fuselage 130 of the rotorcraft 100 in order to transmit forces from the rotor 110 (FIG. 1) to the fuselage 130. For that purpose, the roof beam portions 14 are secured to the structural elements 200 of the rotorcraft cabin 180, which, as aforementioned, may be the forward and aft lift frames of the rotorcraft 100. For that purpose, in the embodiment shown, the transmission support 10 includes attachment members 24 secured to the two side beams 12 and protruding downwardly from the roof beam portion 14. Each of the attachment members 24 has an “L”-shape defined by a first leg secured to the corresponding side beam 12 via suitable fasteners and a second leg securable to the structural elements 200. In the embodiment shown, the attachment members 24 extend through a respective opening 202 defined in the roof 170 of the rotorcraft cabin 180 to be secured to the structural elements 200. Each of the side beams 12 includes two of the attachment members 24, each located adjacent a respective end 12a, 12b (FIG. 3) of the side beam 12. Although the attachment members 24 are shown as being formed separately from the support 10 and attached thereto, it is understood that alternately, the attachment members 24 may be part of the monolithic structure of the support 10.

In a particular embodiment and in use, the transmission 160 is secured to the rotorcraft 100 by securing the monolithic transmission support 10 to the roof 170 of the cabin 180 via the side beams 12. The transmission 160 is received between the side beams 12 within the space S. The transmission 160 is secured to the monolithic transmission support 10 in at least two locations spaced apart from each other. In a particular embodiment, the at least two locations are defined on the pylon beam portions 16 of the monolithic transmission support 10. In the embodiment shown, the transmission 160 is secured to the portion 14a₁ of the top horizontal flange 14a that is common to both the pylon beam portions 16 and the roof beam portions 14 of the side beams 12.

In a particular embodiment, the monolithic transmission support 10 is manufactured by laying uncured composite on a suitable mold surface to form the two side beams 12 and to form the cross-beams 18 interconnecting the side beams 12. Each side beam 12 is formed to include the roof beam portion 14 and the pylon beam portion 16. The composite material is cured to obtain the monolithic transmission support 10. In the embodiment shown, curing the composite material includes heating the composite material under pressure, e.g., under mechanical pressure, under pressure applied by a vacuum bag, and/or under a pressurized atmosphere in an autoclave. It is understood that the uncured composite material is suitably prepared before the cure cycle, such as by vacuum bagging with suitable breather material and caul plates or pressure pads; such preparation methods are well known in the art and will not be discussed further herein.

In the areas of the components that are fully enclosed by the mold parts the pressure is applied, transferred and maintained on all the wall surfaces by the relative movement and bias of the adjacent mold parts along the direction of compaction of the laminates. The laminate thickness of the fully enclosed walls can be controlled by physical stoppers.

The laminate thickness of the walls formed under an open mold configuration can be controlled by the external pressure applied during cure (e.g. vacuum or autoclave pressure). The consolidation pressure during cure can be generated by the autoclave and vacuum bag or by mechanical pressure out of autoclave; it can also/alternatively be generated directly on the laminates and/or by thermal expansion.

It is understood that the term “uncured” as used herein is intended to include material that is partially cured to facilitate handling, but still flexible so as to allow forming to a desired shape, including, but not limited to, prepreg material including B-Stage resin.

In a particular embodiment, having the transmission support 10 formed as a monolithic structure allows decreasing of a part count, increasing of an effective size of the rotor craft cabin, and/or permitting a modularity of a drive system assembly to tailor an efficient and simple load path, as compared to a conventional configuration in which all of the components (e.g., roof beams, pylon beams, cross beams) are manufactured separately from one another and need to be assembled together.

In a particular embodiment, having the transmission support 10 formed as a monolithic structure allows reducing an amount of fasteners that are required for attaching all of the components, as compared to a conventional, non-monolithic, transmission support. The monolithic structure may allow eliminating complicated tension joints at a transmission interface fittings and pylon frames for allowing more cabin room and/or fuel while increasing a stiffness of the rotorcraft cabin roof. The monolithic structure may allow for a continuous lift frame inside the rotorcraft cabin and may allow minimizing of an opening in a one-piece skin of the rotorcraft fuselage.

A torsional loading in the lift frame is directly related to a deflection of the roof beam portions 14, which is function of their bending stiffness. In a particular embodiment, having the monolithic structure outside the rotorcraft cabin 180 allows increasing the inertia of the structure without jeopardizing a volume of the rotorcraft cabin 180, as compared with a rotorcraft having interior roof beams. This might lead to weight savings by reducing a size of the forward and aft lift frames of the rotorcraft cabin 180.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

1. A transmission support configured for securing a transmission on a roof of a rotorcraft cabin, the transmission support comprising:
two side beams each including:
a roof beam portion extending along a longitudinal direction and configured to be secured to structural elements of the rotorcraft cabin, the two side beams spaced apart from each other along a transverse direction perpendicular to the longitudinal direction, and
a pylon beam portion extending from the roof beam portion toward the other of the side beams, the pylon beam portion configured to engage the transmission upon the transmission being received between the side beams; and
cross beams extending between and interconnecting the two side beams, the cross beams spaced apart from each other along the longitudinal direction;
wherein the side beams and cross beams are part of a monolithic structure.

2. The transmission support of claim 1, wherein for each of the two side beams, the roof beam portion has a horizontal flange disposed on top of a body such as to define a T-shaped cross-section, the horizontal flange further defining part of the pylon beam portion, the pylon beam portion further including pylon beam bodies extending downwardly from the horizontal flange and spaced apart from each other along the longitudinal direction, the pylon beam bodies extending from the body of the roof beam portion toward the other of the two side beams.

3. The transmission support of claim 2, wherein for each of the two side beams, the horizontal flange defines a transmission securing interface for attaching the transmission to the pylon beam portion.

4. The transmission support of claim 1, further comprising attachment members protruding downwardly from the roof beam portion of each of the two side beams, the attachment members configured to extend through the roof of the rotorcraft cabin to be secured to the structural elements.

5. The transmission support of claim 4, wherein two of the attachment members are provided for each of the two side beams, each of the two attachment members located adjacent a respective end of the side beam.

6. The transmission support of claim 1, wherein the monolithic structure is made of composite material.

7. The transmission support of claim 6, wherein the composite material includes carbon fibers.

8. The transmission support of claim 1, wherein each of the two side beams further has a beam body spaced apart from the pylon beam portion along the longitudinal direction, the beam body extending downwardly from a horizontal flange disposed on top of a body of the roof beam portion and extending from the body of the roof beam portion toward the other of the two side beams, the beam body configured for supporting components of the rotorcraft.

9. The transmission support of claim 1, wherein each of the cross beams is secured to the two side beams via the pylon beam portions.

10. A monolithic transmission support configured for securing a transmission on a roof of a rotorcraft cabin, the monolithic transmission support comprising two side beams spaced apart from each other along a transverse direction and interconnected to each other via cross beams, the cross beams spaced apart from each other along a longitudinal direction, the longitudinal direction perpendicular to the transversal direction, each of the two side beams including a roof beam portion configured to be received on the roof and to be secured to structural elements of the rotorcraft cabin and a pylon beam portion configured to engage the transmission upon the transmission being received between the side beams, the pylon beam portion protruding from the roof beam portion.

11. The monolithic transmission support of claim 10, wherein for each of the two side beams, the roof beam portion has a horizontal flange disposed on top of a body such as to define a T-shaped cross-section, the horizontal flange further defining part of the pylon beam portion, the pylon beam portion further including pylon beam bodies extending downwardly from the horizontal flange and spaced apart from each other along the longitudinal direction, the pylon beam bodies extending from the body of the roof beam portion toward the other of the two side beams.

12. The monolithic transmission support of claim 11, wherein for each of the two side beams, the horizontal flange defines a transmission securing interface for attaching the transmission to the pylon beam portion.

13. The monolithic transmission support of claim 10, further comprising attachment members protruding downwardly from the roof beam portion of each of the two side beams, the attachment members configured to extend through the roof of the rotorcraft cabin to be secured to the structural elements.

14. The monolithic transmission support of claim 13, wherein two of the attachment members are provided for each of the two side beams, each of the two attachment members located adjacent a respective end of the side beam.

15. The monolithic transmission support of claim 10, wherein the monolithic structure is made of composite material.

16. The monolithic transmission support of claim 15, wherein the composite material includes carbon fibers.

17. The monolithic transmission support of claim 10, wherein each of the two side beams further has a beam body spaced apart from the pylon beam portion along the longitudinal direction, the beam body extending downwardly from a horizontal flange disposed on top of a body of the roof beam portion and extending away from the body of the roof beam portion, the beam body configured for supporting elements of the rotorcraft.

18. The monolithic transmission support of claim 10, wherein each of the cross beams is secured to the two side beams via the pylon beam portions.

19. A method of forming a monolithic transmission support for a rotorcraft, comprising:
laying uncured composite on a mold surface to form two side beams and to form cross-beams interconnecting the side beams, each side beam being formed to include a roof beam portion and a pylon beam portion; and
curing the composite material to obtain the monolithic transmission support.

20. The method of claim 19, wherein curing the composite material includes heating the composite material under pressure.
